(19) United States
(12) Patent Application Publication
(10) Pub. No.: US 2003/0038596 A1
(43) Pub. Date: Feb. 27, 2003

(54) Light-mixing layer and method

(76) Inventor: Wen-Chih Ho, Taipei Hsien (TW)

Correspondence Address: Ladas & Parry, 26 West 61st Street, New York, NY, 10023, US

(21) Appl. No.: 10/084,876

(22) Filed: Feb. 28, 2002

(30) Foreign Application Priority Data
Aug. 21, 2001 (TW) 90120525

(51) Int. Cl. H01J 1/62

(52) U.S. Cl. 313/512

(57) ABSTRACT

The present invention discloses a light-mixing layer and method. At the manufacturing stage, the present invention arranges the particles of the composition in the light-mixing layer in an particle-interlaced order, and makes the light-mixing layer excite another wavelength after absorbing the light emitted from a light source. These two kinds of lights are mixed in the light-mixing layer to obtain a complete light diffusion, light transformation and light mixture to generate a light source with a high uniformity, high brightness and stable color temperature.

### BACKGROUND OF THE INVENTION

1. Field of the Invention

The present invention relates to a light-mixing device, particularly to a light-mixing layer and method.

2. Description of Related Art

Recently, LED (Light-Emitting Diode) components have been popularly used in daily life. Due to the advantages of a small profile, low power consumption, low heat dissipation and long life, LED components have gradually replaced conventional lamps to act as a lighting device. Especially with successful development of a highlight LED and white light LED component, more and more large screen LED displays and indoor ruminants utilize LED components for luminescing, LED components will therefore become more widely used in the future.

A known LED component disclosed in a U.S. Pat. No. 5,998,925 is entitled “LIGHT EMITTING DEVICE HAVING A NITRIDE COMPOUND SEMICONDUCTOR AND A PHOSPHOR CONTAINING A GARNET FLUORESCENT MATERIAL”. The prior LED component includes an LED chip, a phosphor and epoxy, and it uses the light emitted from an LED chip to excite the YAG phosphor contained in a phosphor layer for generating a fluorescent light having a wavelength different from that of the LED component, so the fluorescent light emitted by the phosphor and the light emitted from the LED chip, which is output without contributing to the excitation of the phosphor, are mixed and output a white light. However, the light mixing mentioned above happens only on the surface of the phosphor layer, therefore the effect of light mixing is not satisfactory and the light consumption is very large.

The above phosphor layer is formed by mixing a YAG phosphor and epoxy, and encloses on the surface of the LED chip. After a baking at a high temperature, the phosphor layer is formed. However, after baking the phosphor layer, the YAG phosphor will deposit due to a specific gravity difference from other materials, and the result raises the density of the phosphor layer and also reduces the uniformity of the phosphor layer. The above phenomenon will disturb the normal light emitting of the LED chip, and cause the YAG phosphor to fail completely absorb the light emitted from the LED chip and thereby reducing the luminant efficiency. The light emitted from the LED chip and the light emitted from the YAG phosphor, which is excited by absorbing a portion of the light emitted from the LED chip, cannot reach a complete mixture due to a non-uniform density of the phosphor layer, and the LED component thus does not have a uniform light.

FIG. 1 shows a prior LED component, including an LED chip 11 placed on a chip cup 12, a phosphor layer 15 covering the LED chip 11, an electrode 13, bonding wires 14 connecting the LED chip 11, the electrode 13 and the chip cup 12, respectively, and a transparent encapsulant 16. FIG. 2 shows an enlarged hint diagram of the LED chip 11 and phosphor layer in FIG. 1.

FIG. 3 shows a hint diagram of the phosphor layer 15 of the prior LED component. The phosphor layer is formed by mixing the YAG phosphor 31 and the epoxy 32 filling the gaps among the particles of the YAG phosphor 31 through a high temperature process. FIG. 4 shows a light-mixing principle of the prior LED component. The light emitted from the LED chip 11 and passing through the epoxy 32 filling the gaps among the particles of the YAG phosphor 31 has a wavelength B, and a light excited by the YAG phosphor 31 which absorbs a portion of wavelength B1 has a wavelength Y. The lights of wavelength B and Y form another light of wavelength W, which leaves the surface of the LED chip by different emitting angles. However, since the YAG phosphor and the epoxy 32 have difference specific gravities, after baking, the YAG phosphor will deposit and the density of the phosphor layer will not be kept in a uniform state. Besides, the above light mixing happens only on the emitting surface (or the surface of the phosphor layer) of the LED component. Yet much light will disappear before the mixing happens, and it causes a heavy loss of luminant efficiency.

FIG. 5 shows a corresponding diagram of wavelength vs. ruminant intensity of the prior LED component. It shows that although the necessary wavelength could be obtained by the prior alt light mixing method, however, the luminant efficiency is not satisfactory and the brightness is not enough.

### SUMMARY OF THE INVENTION

The object of the present invention is to provide a light-mixing layer and method, and to generate a specific color light with a high uniformity, high brightness and stable color temperature.

To achieve the above purpose, the present invention arranges the particles of the composition in the light-mixing layer in a particle-interlaced order, and makes the light-mixing layer excite another wavelength after absorbing the light emitted from a light source. These two kinds of lights are mixed in the light-mixing layer to obtain a complete light diffusion, light transformation and light mixture for generating another light source with a high uniformity, high brightness and stable color temperature.

The light-mixing layer and method according to the present invention can obtain at least the following advantages:

1. By adding the light-scattering particles (such as quartz, glass or other polymeric transparent materials) into the light-mixing layer, the density of the phosphor particles will be reduced. Since the transparent property of the light-scattering particles is so good that the light can be completely emitted from the light-mixing layer, the light consumption will be reduced. The light-mixing effect of the present invention is independent on the density of the phosphor particles; therefore the light-mixing effect is excellent.

2. By the scatteration of the light-scattering particles, the light emitted from the light source can completely excite the phosphor particles in every layer of the light-mixing layer and convert into a higher wavelength light.

3. By adding the diffuser particles (such as BaTiO₃, Ti₂O₃, SiOₓ) into the light-mixing layer of the present invention, the light emitted from the light source and the light excited by the phosphor particles will be completely mixed and light consumption will be reduced. By several times of circular mixtures, another light source with a high uniformity, high brightness and stable color temperature will be obtained.

### BRIEF DESCRIPTION OF THE DRAWINGS

The present invention is described according to the appended drawings in which:

FIG. 1 shows a cross-sectional view of a prior art LED component;

FIG. 2 shows a phosphor layer of a prior art LED component;

FIG. 3 shows a light-emitting and light-mixing process of a prior art LED component;

FIG. 4 shows a light-mixing application of a prior art LED chip and phosphor layer;

FIG. 5 shows a light-mixing spectrum of a prior art LED component;

FIG. 6 shows a light-mixing layer according to the present invention;

FIG. 7 shows a light-mixing application of an LED chip and phosphor layer according to the present invention;

FIG. 8 shows a light-mixing method of the present invention;

FIG. 9 shows a hint diagram of a light-mixing process of the present invention; and

FIG. 10 shows a light spectral diagram of the present invention.

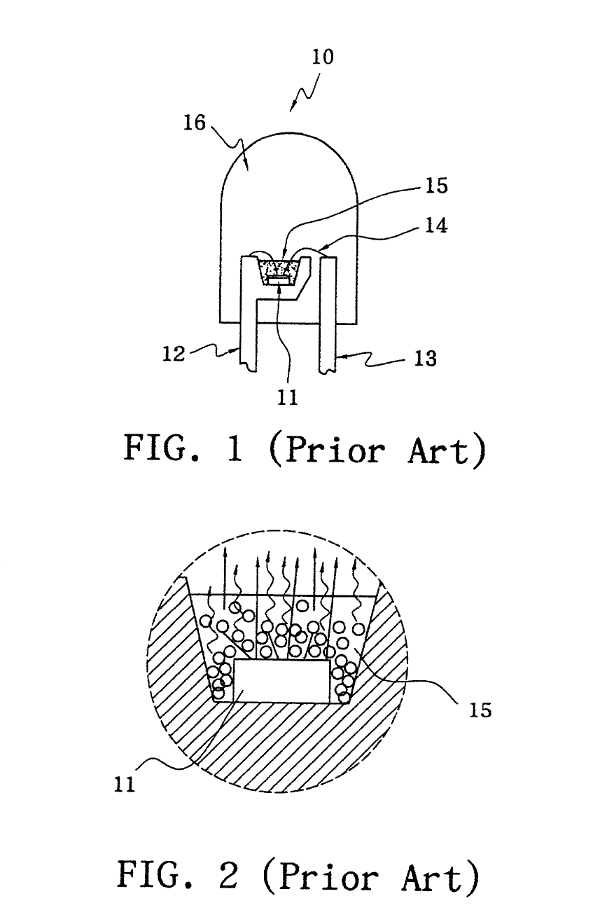

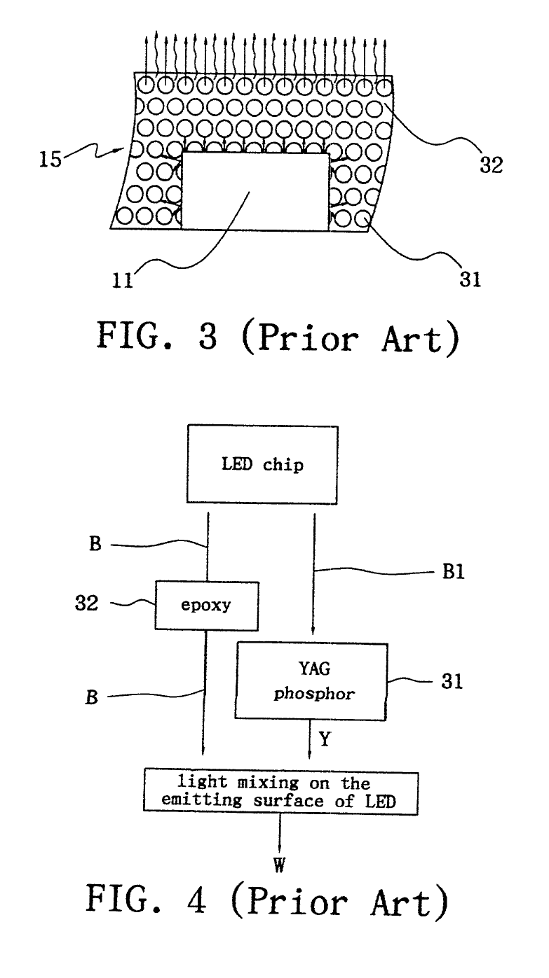

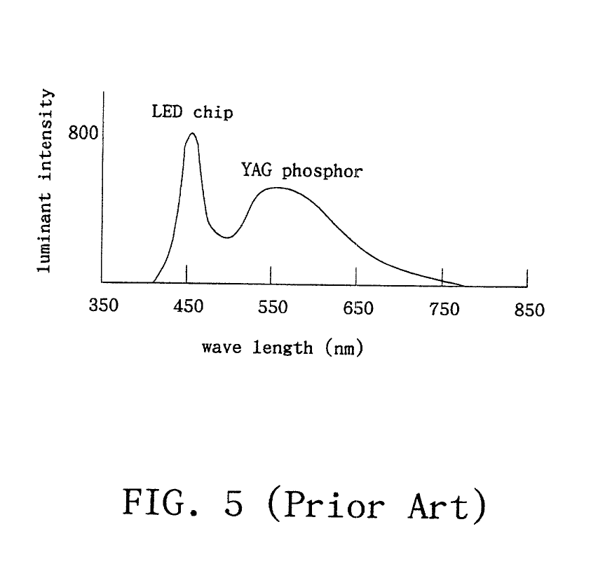

### PREFERRED EMBODIMENT OF THE PRESENT INVENTION

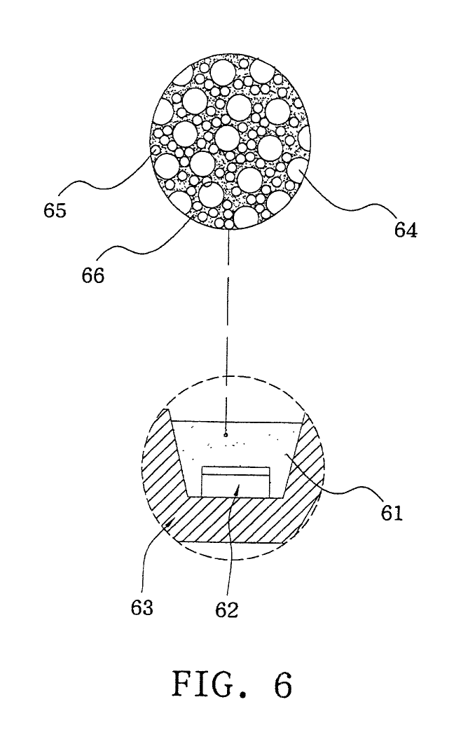

As in FIG. 6, the light-mixing layer 61 according to one embodiment of the present invention is placed on a chip cup 63, and it can mix with an epoxy and enclose a LED chip 62 (an example of a light source) for completely absorbing the light emitted from the LED chip 62. The light-mixing layer 61 is composed of light-scattering particles 64, phosphor particles 65 and diffuser particles 66. The light-scattering particles 64 could be made of quartz, glass or other polymeric transparent materials, the phosphor particles 65 could be made of YAG phosphor particles and the diffuser particles 66 could be made of BaTiO₃, Ti₂O₃ and SiOₓ. After a baking or UV line illumination, the light-scattering particles 64, phosphor particles 65 and diffuser particles 66 will be arranged in a particle-interlaced order by the methods of inertial force, expressure, condensation, etc.

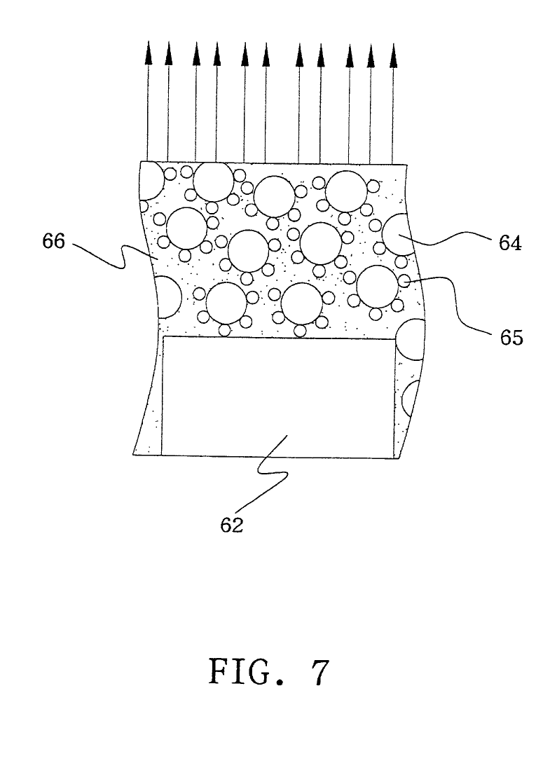

In FIG. 7, a portion of light emitted from the LED chip 62 changes its ongoing directions by the light-scattering particles 64, and the phosphor particles 65 convert the light emitted from the light-scattering particles 64 and diffuser particles 66 which release the light of the LED chip 62, into another wavelength light. The diffuser particles 66 are used to mix the above lights of different wavelengths. Since the light-scattering particles 64, phosphor particles 65 and diffuser particles 66 are arranged in a particle-interlaced order, the phosphor particles 65 of the light-mixing layer can reach a saturated absorption state and release another wavelength. Through the continuing light mixing among the light-scattering particles 64, phosphor particles 65 and diffuser particles 66, a uniform, bright and constant-color-temperature light can be obtained (indicated by arrows).

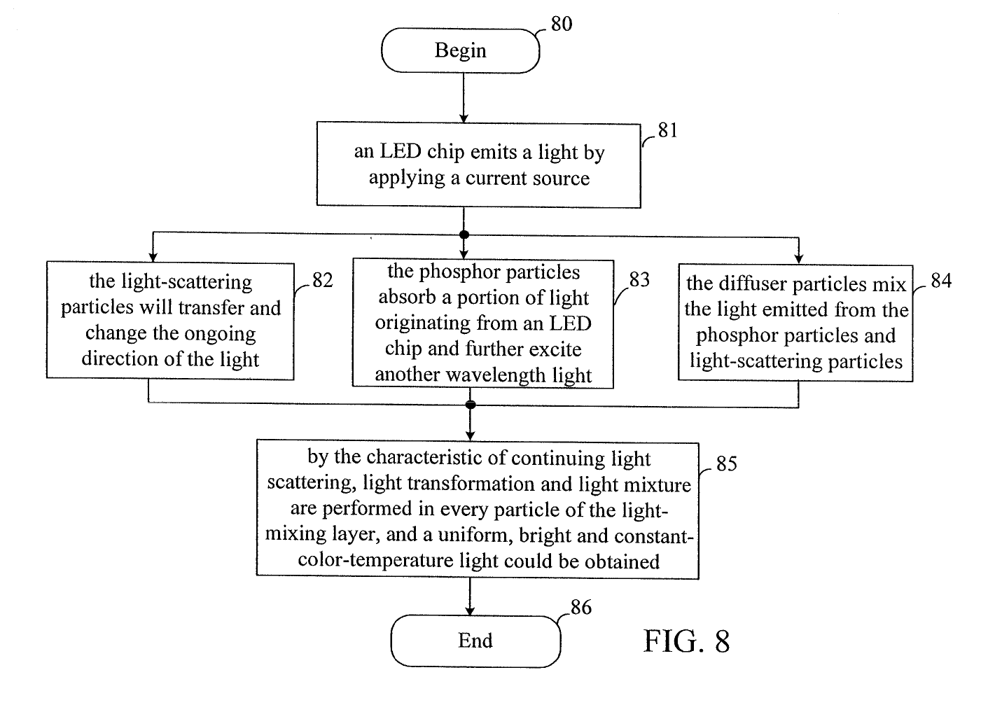

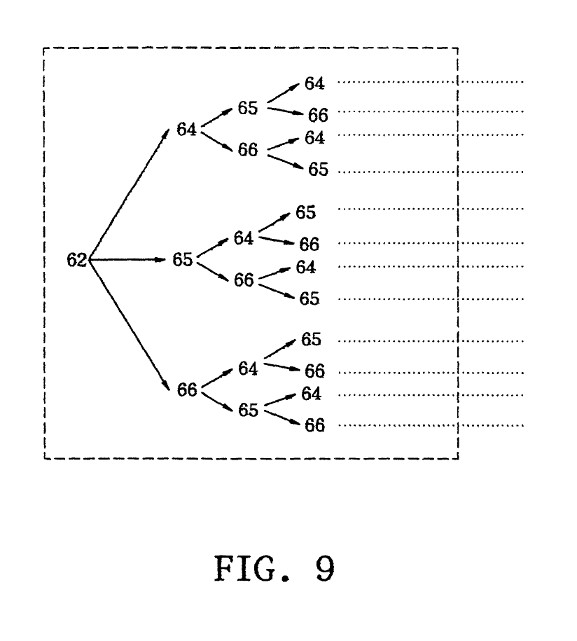

FIG. 8 shows a light-mixing flow chart of the present invention. In step 81, an LED chip 62 emits a light by applying a current source. In step 82, after the LED chip 62 emits a light into the light-mixing layer 61, the light-scattering particles 64 in the light-mixing layer 61 will transfer and change the ongoing direction of the light. In step 83, the phosphor particles 65 absorb a portion of light emitted from the light-scattering particles 64 and diffuser particles 66 and further excite another wavelength light. In step 84, the diffuser particles 66 mix the light emitted from the phosphor particles 65 and light-scattering particles 64. In step 85, by the characteristic of continuing light scattering, light transformation and light mixture are performed in every particle (including the light-scattering particles 64, phosphor particles 65 and diffuser particles 66) of the light-mixing layer, and a uniform, bright and constant-color-temperature light can be obtained.

FIG. 9 shows a hint diagram of a light-mixing process of the present invention. First, the LED chip 62 emits a light into the light-mixing layer. Next, the first light-mixing process starts, that means a portion of light from the LED chip 62 emits into the transparent light-scattering particles 64, which scatter the light into the phosphor particles 65 and diffuser particles 66; a portion of light from the LED chip 62 emits into the diffuser particles 66, which scatter the light into the phosphor particles 65 and light-scattering particles 64; and a portion of light from the LED chip 62 emits into the phosphor particles 65, which are excited and convert another wavelength light to the light-scattering particles 64 and diffuser particles 66. By the same rule, the subsequent light-mixing processes are continued. The lights of two different wavelengths are completely mixed through the particle-interlaced order of the light-mixing layer, and by the characteristic of continuing light scattering, light transformation and light mixture in every particle of the light-mixing layer, a uniform, bright and constant-color-temperature light can be obtained.

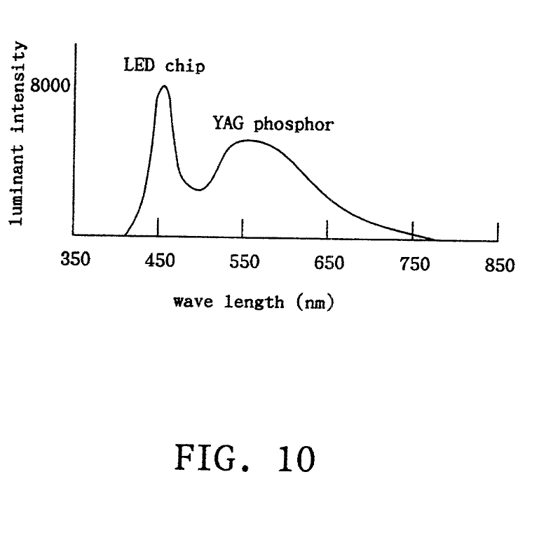

FIG. 10 shows a light spectral diagram of the present invention. It is shown in this drawing that the luminant efficiency of the present invention is much better than that of the prior LED component, and the ruminant intensity of the present invention is much higher than that of the prior LED component.

The light-mixing layer of the LED component according to the present invention could be formed by a process of dispersion, printing, SPIN, cladding or evaporation, etc., and the LED chip is enclosed by a process of deposition, inertial force, expressure, condensation, coating, sputtering, cladding or evaporation, etc. Besides, the light-mixing layer can keep a distance from the LED chip, and absorb the light emitted from the LED chip by reflectance, and the present invention does not limit any connecting relationship between the light-mixing layer and the LED chip. Furthermore, the ratio of the light-scattering particles 64, phosphor particles 65 and diffuser particles 66 in the light-mixing layer can be dynamically adjusted according to a demanded output wavelength. However, generally speaking, it is better to keep the light-scattering particles 64 occupy 10% to 70% by weight, the phosphor particles 65 occupy 10% to 65% by weight and the diffuser particles 66 occupy 15% to 60% by weight. The principle of the present invention is also suitable for manufacturing an EL slice or other fields. The present invention is not limited to a specific application, such as a LED.

The above-described embodiments of the present invention are intended to be illustrative only. Numerous alternative embodiments may be devised by those skilled in the art without departing from the scope of the following claims.

What is claimed is:

1. A light-mixing layer for absorbing a light source, comprising:
light-scattering particles for scattering the light emitted from the light source;
phosphor particles for converting a portion of the light originating from the light source into another wavelength light; and
diffuser particles for mixing the light emitted from the light-scattering particles and the phosphor particles;
wherein the light-scattering particles, phosphor particles and diffuser particles are arranged in a particle-interlaced order.

2. The light-mixing layer of claim 1, wherein an arrangement of the light-scattering particles, diffuser particles and phosphor particles is made by a process of printing, dispersion, SPIN, evaporation, inertial force, expressure, condensation, cladding or sputtering.

3. The light-mixing layer of claim 1, wherein the light-scattering particles are made of quartz, glass or polymeric transparent materials.

4. The light-mixing layer of claim 1, wherein the diffuser particles are selected from a group consisting of BaTiO₃, Ti₂O₃ and SiOₓ.

5. The light-mixing layer of claim 1, wherein the phosphor particles are made of an inorganic phosphor matter.

6. The light-mixing layer of claim 1, which covers the light source by a process of inertial force, expressure or condensation.

7. The light-mixing layer of claim 1, which covers the light source by a coating or printing process.

8. The light-mixing layer of claim 1, which covers the light source by a sputtering, cladding or evaporation process.

9. The light-mixing layer of claim 1, which keeps a distance from the light source, and absorbs the light emitted from the light source by reflection.

10. The light-mixing layer of claim 1, wherein the light-scattering particles occupy 10% to 70% by weight, the phosphor particles occupy 10% to 65% by weight and the diffuser particles occupy 15% to 60% by weight.

11. An LED component, comprising a chip, a chip cup, electrodes and a transparent encapsulant, characterized in that the LED component includes a light-mixing layer for absorbing light emitted from the LED chip, the light-mixing layer including light-scattering particles for scattering the light emitted from the LED chip, phosphor particles for converting a portion of the light originating from the LED chip into another wavelength light and diffuser particles for mixing the light emitted from the light-scattering particles and the phosphor particles, wherein the light-scattering particles, phosphor particles and diffuser particles are arranged in a particle-interlaced order.

12. The LED component of claim 11, wherein the light-mixing layer covers the LED chip by a process of inertial force, expressure or condensation.

13. The LED component of claim 11, wherein the light-mixing layer covers the LED chip by a coating or printing process.

14. The LED component of claim 11, wherein the light-mixing layer covers the LED chip by a sputtering, cladding or evaporation process.

15. The LED component of claim 11, wherein the light-mixing layer keeps a distance from the LED chip, and the light-mixing layer absorbs the light emitted from the LED chip by reflection.

16. A light-mixing method, comprising the following steps:
providing a light-mixing layer including light-scattering particles, phosphor particles and diffuser particles, and the light-mixing layer used for absorbing the light emitted from a light source;
utilizing the light-scattering particles to scatter the light emitted from the light source;
utilizing the phosphor particles to convert a portion of the light originating from the light source into another wavelength light; and
utilizing the diffuser particles to mix the light emitted from the light-scattering particles and the phosphor particles.

17. The light-mixing method of claim 16, wherein an arrangement of the light-scattering particles, diffuser particles and diffuser particles is made by a process of printing, dispersion, SPIN, evaporation, inertial force, expressure, condensation, cladding or sputtering.

18. The light-mixing method of claim 16, wherein an arrangement of the light-scattering particles, phosphor particles and diffuser particles is dependent on a usage level of gravitation, inertia, pressure and solidification.

19. The light-mixing method of claim 16, wherein the light-scattering particles are made of quartz, glass or polymeric transparent materials.

20. The light-mixing method of claim 16, wherein the diffuser particles are selected from a group consisting of BaTiO₃, Ti₂O₃ and SiOₓ.

21. The light-mixing method of claim 16, wherein the phosphor particles are made of an inorganic phosphor matter.

22. The light-mixing method of claim 16, wherein the light-scattering particles occupy 10% to 70% by weight, the phosphor particles occupy 10% to 65% by weight and the diffuser particles occupy 15% to 60% by weight.
